(19) United States
(12) Patent Application Publication
(10) Pub. No.: US 2005/0017696 A1
(43) Pub. Date: Jan. 27, 2005

(54) Method and device for regulating electric voltage

(76) Inventor: Hansjorg Hauer, Vienna (AT)

Correspondence Address: GREENBLUM & BERNSTEIN, P.L.C., 1950 ROLAND CLARKE PLACE, RESTON, VA, 20191, US

(21) Appl. No.: 10/848,352

(22) Filed: May 19, 2004

Related U.S. Application Data
(63) Continuation of application No. PCT/AT02/00321, filed on Nov. 19, 2002.

(30) Foreign Application Priority Data
Nov. 20, 2001 (AT) A 1823/01

(51) Int. Cl. G05F 1/613

(52) U.S. Cl. 323/225

(57) ABSTRACT

Apparatus and method for regulating electric voltage in at least one of electric supply networks and consumer units. The apparatus utilizes a regulating transformer, conducting a nominal current and positioned between a generator and at least one end consumer, including a regulating winding with a plurality of switchable partial windings. A transfer switch is arranged to contact tappings of the switchable partial windings. The regulating transformer includes a leakage gap such that, in the event of a short circuit between adjacent tappings of the switchable partial windings, the regulating winding has a high leakage impedance that limits a resultant ring current to an order of magnitude of the nominal current. This Abstract is not intended to define the invention disclosed in the specification, nor intended to limit the scope of the invention in any way.

### CROSS-REFERENCE TO RELATED APPLICATIONS

The present application is a Continuation of International Patent Application No. PCT/AT02/00321 filed Nov. 19, 2002 and published as WO 03/044611 on May 30, 2003, and claims priority of Austrian Patent Application No. A 1823/01 filed Nov. 20, 2001. Moreover, the disclosure of International Patent Application No. PCT/AT02/00321 is expressly incorporated by reference herein in its entirety.

### BACKGROUND OF THE INVENTION

1. Field of the Invention

The invention relates to a method for regulating the electrical voltage in electrical supply networks and/or consumer units with a regulating transformer and a device for carrying out said method.

2. Discussion of Background Information

Such a method is known from WO 01/33308 A1. As described in this publication, it is generally known to carry out voltage regulation only in the central network nodes of high or medium voltage networks. Further transformation to low-voltage level normally cannot be regulated under load. This network structure is oriented towards the central power supply and has the disadvantage that voltage fluctuations caused by a change in node cannot be adjusted for between the network node and the end consumer. Thus, the exploitable transfer capacity of the network components downstream from the network nodes is limited by the drop in voltage rather than by thermal strength.

Regulating transformers are provided for voltage regulation of the networks in the central network nodes. Regulating transformers are used for incremental voltage regulation in electrical networks by changing the transformer ratio. For this purpose, regulating transformers are fitted with regulating windings with tappings, which can be switched under load. During the switching processes, the load current must not be interrupted and the winding step between the relevant tappings must not be shorted. The second requirement results from the fact that during each switching process between two neighbouring tappings they are necessarily briefly connected to each other due to the first requirement, so that there is a ring current equivalent to the transformer short-circuit current between the switch and the relevant winding, the action of which the transformer is unable to withstand, especially during periodical operation. This transformer short-circuit current is relatively high, since the internal resistance of the transformer is normally small. Furthermore, the incremental switches of the transformers would have to be coordinated with the periodical switching of these high short-circuit currents.

For the above reasons, the switching process in the incremental switch of the transformer does not happen directly but rather in multiple stages, whereby transition impedances are briefly switched into the circuits of the tappings during the switching process, limiting the ring current. In Europe, ohmic transition impedances are common, and in America inductive transition impedances are common. For multi-phase switching, a number of switching principles are applied that are named after the vector diagrams of the switching processes. For example we speak of symmetrical or asymmetrical flag switching.

The disadvantage of the measures used so far to limit the ring current is that they result in complex transition principles and require complex designs of the regulating transformers.

### SUMMARY OF THE INVENTION

The aim of this invention is therefore to create a method of the type mentioned above that on the one hand avoids the above disadvantages and on the other hand allows or guarantees a better and more efficient use of the existing networks through a new field of voltage regulation application that is closer to the consumer.

The problem is solved by this invention.

The method according to the invention is characterised by the fact that in the course of the energy flow between at least one generator and at least one end consumer the regulation transformer is looped in with a switch for switching over the part-windings of the regulating transformer, whereby the regulating transformer has a high transition impedance that limits the circulating current in the case of a short between adjacent tappings of the part-winding to the magnitude of the rated current.

With this invention it is for the first time possible to carry out voltage regulation in networks or consumer units in proximity to the consumer and on the basis of regulating transformers that have an increased impedance of the regulating windings, so that a simplified step switch without transition impedances can be used.

With the liberalisation and decentralisation of electric power supply and due to the higher bi-directional work-load of the networks, the voltage differences between heavy-duty consumption, low duty and possibly the power supply will become greater on the consumer side. To maintain the voltage there should therefore be voltage regulation at the level of the low voltage or possibly at the level of the medium voltage as an economic solution.

It is a further aim of the invention to provide a device for carrying out this method, which has a simple and robust structure and operation and which can be manufactured economically.

In accordance with a particular feature of the invention the device for carrying out the method is characterised by the fact that the regulating transformer is designed as a single winding transformer, e.g. as an autotransformer, or a multiple winding transformer, e.g. as a full transformer.

In accordance with a further embodiment of the invention, the regulating transformer is designed with a regulating winding on the primary and/or secondary side that is connected to the winding ends and/or tappings of the master winding via the winding ends and/or tappings.

In accordance with a further embodiment of the invention, the regulating transformer is designed with a regulating winding on the intermediate circuit side.

In accordance with a further special feature of the invention, the regulating transformer is designed as a two-winding transformer with regulating winding on the primary and/or secondary side.

In accordance with a further embodiment of the invention, the regulating transformer is designed as a longitudinal regulator with differential capacity in proportion with the voltage difference to be regulated.

In accordance with the invention, regulating transformers or longitudinal regulators are provided to maintain voltage, in which the regulating windings to adjust the voltage on the load side have a high own impedance or leakage impedance that acts as transition impedance integrated in the regulating transformer so that the transition impedances of the step switch known from the state of the art and common today, and thus the resistance contacts are not required.

Since the high leakage impedance occurs only in the regulating winding of the regulating transformer, it only has a small effect on the total internal resistance of the network.

The need for transition impedances results from the fact that for reasons of voltage maintenance the internal network resistance and short-circuit impedance of regulating transformers is much lower than the load impedance, so that the ring currents without switch-over resistance occurring during the switch-over processes are at the level of short-circuit currents and thus significantly higher than the operating currents.

If the short-circuit impedance of the regulator winding is increased, e.g. by widening the leakage gap, so that the ring current occurring during the switch-over in the case of a short circuit between adjacent tappings is of the order of magnitude of the nominal current, the additional transition impedances are not required and the step switch is simplified into a normal transfer switch.

The regulating winding can be designed in any form, e.g. as a concentric winding or as a flat coil winding, with the relevant tappings. This principle can be applied both to full transformers with regulating winding and to autotransformers for longitudinal regulation. The regulating winding can be connected to the winding ends and/or tappings of the primary and/or secondary and/or master winding on the intermediate circuit side both through the winding ends and through tappings.

Since the device is suitable primarily for the voltage regulation of network spurs, its capacity based on the transitional capacity lies within a range of a some 10 kVA to some 10 MVA.

In a further embodiment of the invention, the transfer switch is a load switch without resistance contact and with only main contacts. As already shown above, such a load transfer switch offers an economical solution.

In a further embodiment of the invention, the transfer switch is a load selector without resistance contacts. This embodiment of the transfer switch also has an extremely simple structure and can be produced economically.

In further embodiments of the invention, the transfer switch can also be designed on the basis of a multi-phase camshaft controller or a chain of relays or contactors or their components or a chain of electronic switches, in particular semiconductor switches. These embodiments of the transfer switch also have a simple structure and are extremely reliable in robust operations. Naturally these transfer switches can be based on any switching principle, such as e.g. air switching systems, switching systems under oil or SF6, as well as vacuum switching systems.

The invention also provides for a method of regulating an electric voltage in at least one of electric supply networks and consumer units with a regulating transformer located between at least one generator and at least one end consumer, in which the regulating transformer conducts a nominal current and has a regulating winding with switchable partial windings, the method comprising switching the partial windings of the regulating transformer with a transfer switch, whereby, in an event of a short circuit between adjacent tappings of the partial windings, the regulating winding has a high leakage impedance that limits a resultant ring current to an order of magnitude of the nominal current.

The invention also provides for an apparatus for regulating electric voltage in at least one of electric supply networks and consumer units, the apparatus comprising a regulating transformer, conducting a nominal current and positioned between a generator and at least one end consumer, comprising a regulating winding with a plurality of switchable partial windings. A transfer switch is arranged to contact tappings of said switchable partial windings. Said regulating transformer comprises a leakage gap such that, in the event of a short circuit between adjacent tappings of said switchable partial windings, said regulating winding has a high leakage impedance that limits a resultant ring current to an order of magnitude of the nominal current.

The transfer switch may comprise a load switch without resistance contacts. The load switch may include only main contacts. The transfer switch may comprise a load selector. The load selector may be arranged without resistance contacts. The transfer switch may comprise a multi-phase camshaft controller. The transfer switch may comprise one of a controller and a component of a camshaft controller. The transfer switch may comprise a chain of one of relays and contactors. The transfer switch may comprise one of a relay and a component of a contactor. The transfer switch may comprise a chain of electronic switches. The chain of electronic switches may comprise semiconductor switches. The transfer switch may comprise electronic switches. The electronic switches may comprise semiconductor switches. The regulating transformer may be a longitudinal transformer. The regulating transformer may be a single winding transformer. The regulating transformer may be an autotransformer. The regulating transformer may be a multiple winding transformer. The regulating transformer may be a full transformer.

The regulating winding may comprise at least one of winding ends and tappings which are connected to at least one of winding ends and tappings of regulating windings of a primary winding. The regulating winding may comprise at least one of winding ends and tappings which are connected to at least one of winding ends and tappings of regulating windings of a secondary winding.

The apparatus may further comprise a primary winding and a secondary winding disposed between the primary winding and the partial windings.

The regulating transformer may comprise a dual winding transformer. The dual winding transformer may comprise a regulating winding arranged on a primary side. The dual winding transformer may comprise a regulating winding arranged on a secondary side.

The invention also provides for a method of regulating an electric voltage in electric supply networks and consumer units, wherein the method comprises arranging a regulating transformer between a generator and at least one end consumer, wherein the regulating transformer comprises a primary winding and a regulating winding which includes switchable partial windings and a high leakage impedance, conducting a nominal current in the regulating transformer, switching the partial windings of the regulating transformer with a transfer switch, and short circuiting adjacent tappings of the partial windings, wherein the high leakage impedance limits a ring current to an order of magnitude of the nominal current during the short circuiting, and wherein the regulating transformer produces both an increase in voltage and a decrease in voltage at the end consumer.

The regulating transformer may be a longitudinal transformer. The regulating transformer may be one of a full transformer and a single winding transformer. The regulating winding may be connected to the primary winding. The regulating transformer may further comprise a secondary winding and wherein the regulating winding is connected to one of the primary winding and the secondary winding. The regulating transformer may be adapted to regulate voltages in the range of 10 kVA and 10 MVA.

The invention also provides for an apparatus for regulating an electric voltage in at least one of electric supply networks and consumer units, wherein the apparatus comprises a regulating transformer arranged between a generator and at least one end consumer. The regulating transformer comprises a primary winding and a regulating winding which includes switchable partial windings and a high leakage impedance, the transformer conducting a nominal current. A transfer switch switches the partial windings of the regulating transformer. Adjacent tappings of the partial windings are adapted to short circuit such that, in an event of the short circuit, the high leakage impedance limits a ring current which results from the short circuit to an order of magnitude of the nominal current. The regulating transformer produces both an increase in voltage and a decrease in voltage at the end consumer.

### BRIEF DESCRIPTION OF THE DRAWINGS

The invention is explained in more detail on the basis of the embodiments illustrated in the figures. The figures show:

FIG. 1 a basic sketch of the arrangement of an autotransformer with regulating winding on the secondary side;

FIG. 2 a basic sketch of the arrangement of a full transformer with regulating winding on the secondary side, which is connected through its winding end with one winding end of the master winding;

FIG. 3 a basic sketch of the arrangement of an autotransformer with regulating winding on the primary side;

FIG. 4 a basic sketch of the arrangement of a full transformer with regulating winding on the primary side, which is connected through a winding tapping with one winding tapping of the master winding;

FIG. 5 a transfer switch based on contactors; and

FIG. 6 a transfer switch based on semiconductors.

### DETAILED DESCRIPTION OF THE PRESENT INVENTION

By way of introduction, it is noted that in the described embodiment the same parts and the same states are allocated the same reference numbers and the same component names, whereby the disclosures contained throughout the description can be applied by analogy to the same parts and the same states with the same reference numbers or same component names.

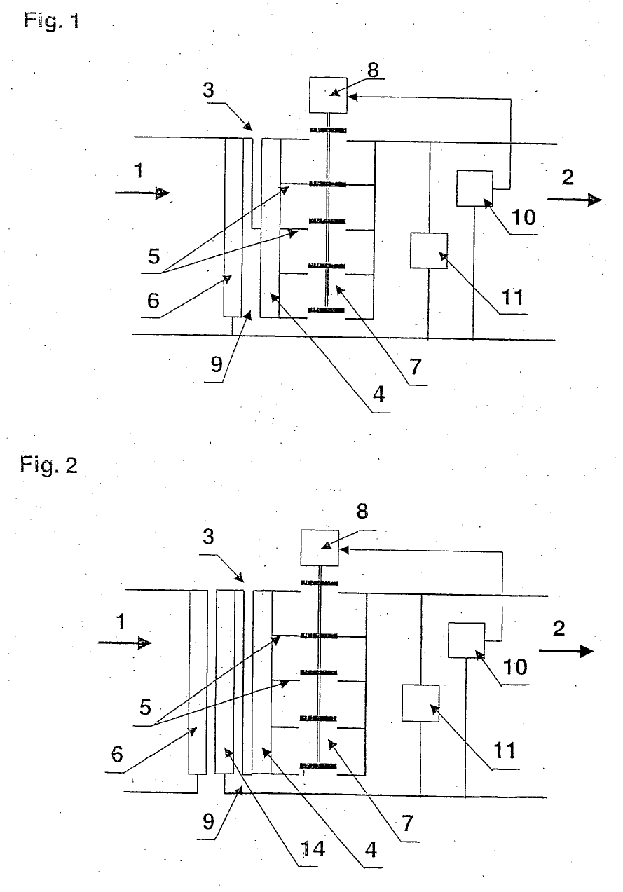

FIG. 1 shows a device for regulating the electric voltage between one generator 1—represented by the arrow—and one end consumer 2—also represented by an arrow—whereby a regulating transformer 3 in the form of an autotransformer is provided for regulating the voltage. This autotransformer has a regulating winding with partial windings 4 on the secondary side. The regulating winding is connected to the primary winding 6 of the autotransformer via a tapping 5, for example via a middle tapping. This allows both an increase and a decrease in voltage on the consumer side. The tappings 5 of the regulating winding are optionally connected with the output to the end consumer 2 via a transfer switch 7. The transfer switch 7 is controlled either via the control unit 8 without regulation or via a voltage controller 10 with regulation. The transitions are made in steps by closing a break adjacent to a closed break and then opening the original break. This allows the voltage on the consumer side to be increased or decreased. In addition, an integrated overvoltage protection 11 can be provided on the side of the end consumer 2.

To increase the short-circuit impedance of the regulating winding, the regulating transformer 3 in the embodiment as an autotransformer has a widened leakage gap 9. Through this increase in leakage impedance, the ring current is limited to the order of magnitude of the nominal current in the case of a short circuit.

In FIG. 2 the device for regulating the electric voltage is again arranged between a generator 1 and an end consumer 2, whereby a regulating transformer 3 in the embodiment of a full transformer with regulating windings on the secondary side is provided for regulation. Thereby, the connection between the regulating winding and the partial windings 4 is provided through their winding end to one winding end of the master winding of the regulating transformer 3 on the secondary side. A transfer switch 7 with control unit 8 is again provided at the partial windings 4. To increase the leakage impedance, the regulating transformer 3 again has a widened leakage gap 9. The leakage impedance of the secondary winding 14 is not increased.

The transfer switch 7 is designed as a multi-phase camshaft controller and corresponds with the tappings 5 of the partial windings 4.

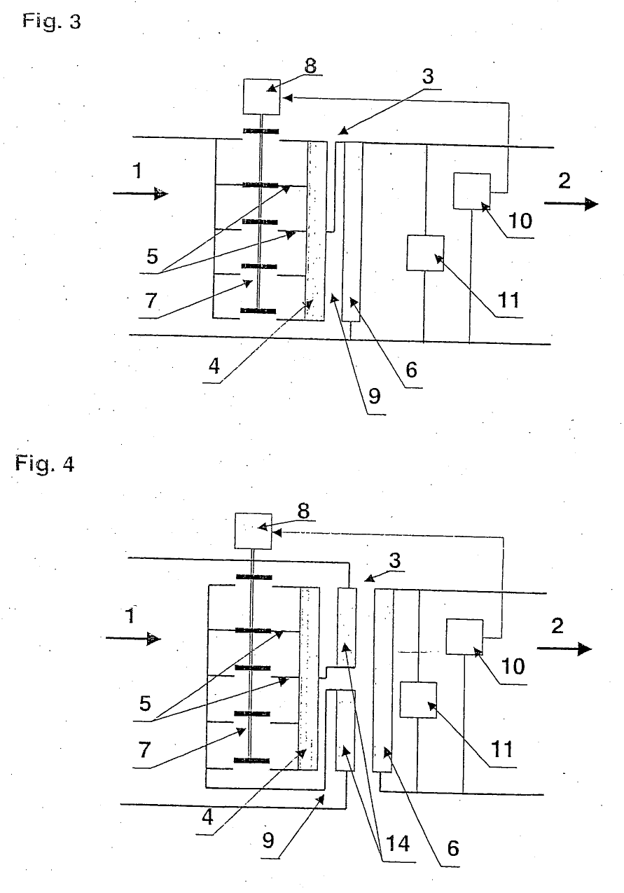

In FIG. 3 the device for regulating the electric voltage is arranged between a generator 1 and an end consumer 2, whereby a regulating transformer 3 in the embodiment of an autotransformer is provided for regulation. This autotransformer has a regulating winding with partial windings 4 on the primary side. The regulating winding is connected to the primary winding 6 of the autotransformer via a tapping 5, for example via a middle tapping. This allows both an increase and a decrease in voltage on the consumer side. The tappings 5 of the regulating winding are optionally connected with the output to the end consumer 2 via a transfer switch 7. The transfer switch 7 is controlled either via the control unit 8 without regulation or via a voltage controller 10 with regulation. The transitions are made in steps by closing a break adjacent to a closed break and then opening the original break. This allows the voltage on the consumer side to be increased or decreased. In addition, an integrated overvoltage protection 11 can be provided on the side of the end consumer 2.

To increase the short-circuit impedance of the regulating winding, the regulating transformer 3 in the embodiment as an autotransformer has a widened leakage gap 9. Through this increase in leakage impedance, the ring current is limited to the order of magnitude of the nominal current in the case of a short circuit.

In FIG. 4 the device for regulating the electric voltage is again arranged between a generator 1 and an end consumer 2, whereby a regulating transformer 3 in the embodiment of a full transformer with regulating windings on the primary side is provided for regulation. Thereby, the connection between the regulating winding and the partial windings 4 is provided through their winding tapping to one winding tapping of the master winding of the regulating transformer 3. A transfer switch 7 with control unit 8 is again provided at the partial windings 4. To increase the leakage impedance, the regulating transformer 3 again has a widened leakage gap 9. The leakage impedance of the secondary winding 14 is not increased.

The transfer switch 7 is designed as a multi-phase camshaft controller and corresponds with the tappings 5 of the partial windings 4.

In accordance with FIG. 5, the partial windings 4 with their tappings 5 are connected with a series of contactors 12, which carry out the voltage regulation in accordance with the transfer switch 7 in FIGS. 1 and 2. The individual contactors 12 or relays are controlled via control units 8 that are connected to a voltage regulator.

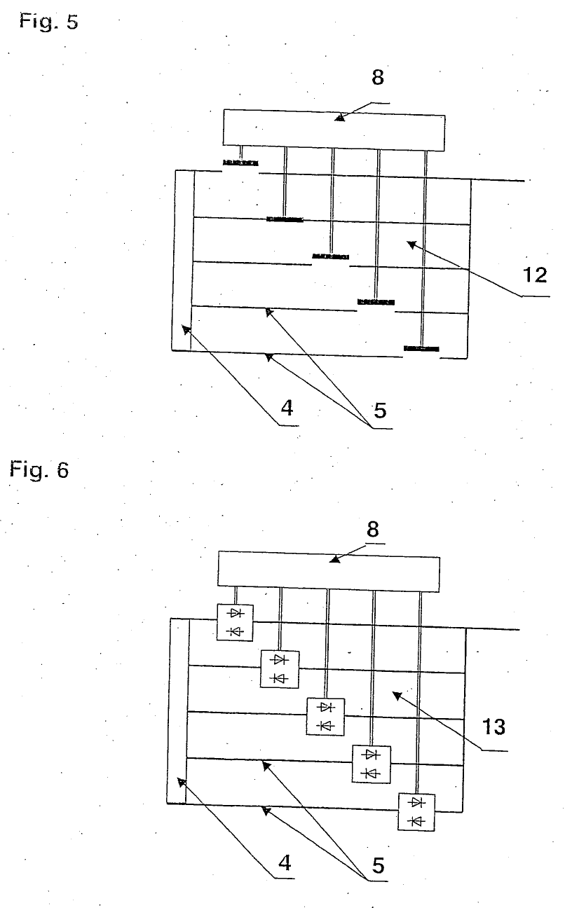

In accordance with FIG. 6, the partial windings 4 with their tappings 5 are connected with a series of electronic switches 13, in particular semiconductor switches, which carry out the voltage regulation in accordance with the transfer switch 7 in FIGS. 1 and 2. The individual semiconductor switches are controlled via electronic units that are connected with the voltage regulator.

For form's sake, it is noted that for a better understanding of the invention the components are illustrated partly untrue to scale and/or are enlarged and/or made smaller.

1-10. (canceled).

11. A method of regulating an electric voltage in at least one of electric supply networks and consumer units with a regulating transformer located between at least one generator and at least one end consumer, in which the regulating transformer conducts a nominal current and has a regulating winding with switchable partial windings, the method comprising:
switching the partial windings of the regulating transformer with a transfer switch, whereby, in an event of a short circuit between adjacent tappings of the partial windings, the regulating winding has a high leakage impedance that limits a resultant ring current to an order of magnitude of the nominal current.

12. An apparatus for regulating electric voltage in at least one of electric supply networks and consumer units, the apparatus comprising:
a regulating transformer, conducting a nominal current and positioned between a generator and at least one end consumer, comprising a regulating winding with a plurality of switchable partial windings;
a transfer switch arranged to contact tappings of said switchable partial windings;
said regulating transformer comprising a leakage gap such that, in the event of a short circuit between adjacent tappings of said switchable partial windings, said regulating winding has a high leakage impedance that limits a resultant ring current to an order of magnitude of the nominal current.

13. The apparatus of claim 12, wherein said transfer switch comprises a load switch without resistance contacts.

14. The apparatus of claim 13, wherein said load switch includes only main contacts.

15. The apparatus of claim 12, wherein said transfer switch comprises a load selector.

16. The apparatus of claim 15, wherein said load selector is arranged without resistance contacts.

17. The apparatus of claim 12, wherein said transfer switch comprises a multi-phase camshaft controller.

18. The apparatus of claim 12, wherein said transfer switch comprises one of a controller and a component of a camshaft controller.

19. The apparatus of claim 12, wherein said transfer switch comprises a chain of one of relays and contactors.

20. The apparatus of claim 12, wherein said transfer switch comprises one of a relay and a component of a contactor.

21. The apparatus of claim 12, wherein said transfer switch comprises a chain of electronic switches.

22. The apparatus of claim 21, wherein the chain of electronic switches comprises semiconductor switches.

23. The apparatus of claim 12, wherein said transfer switch comprises electronic switches.

24. The apparatus of claim 23, wherein the electronic switches comprise semiconductor switches.

25. The apparatus of claim 12, wherein the regulating transformer is a longitudinal transformer.

26. The apparatus of claim 12, wherein the regulating transformer is a single winding transformer.

27. The apparatus of claim 12, wherein the regulating transformer is an autotransformer.

28. The apparatus of claim 12, wherein the regulating transformer is a multiple winding transformer.

29. The apparatus of claim 12, wherein the regulating transformer is a full transformer.

30. The apparatus of claim 12, wherein the regulating winding comprises at least one of winding ends and tappings which are connected to at least one of winding ends and tappings of regulating windings of a primary winding.

31. The apparatus of claim 12, wherein the regulating winding comprises at least one of winding ends and tappings which are connected to at least one of winding ends and tappings of regulating windings of a secondary winding.

32. The apparatus of claim 12, further comprising a primary winding and a secondary winding disposed between the primary winding and the partial windings.

33. The apparatus of claim 12, wherein the regulating transformer comprises a dual winding transformer.

34. The apparatus of claim 33, wherein the dual winding transformer comprises a regulating winding arranged on a primary side.

35. The apparatus of claim 33, wherein the dual winding transformer comprises a regulating winding arranged on a secondary side.

36. A method of regulating an electric voltage in electric supply networks and consumer units, the method comprising:
arranging a regulating transformer between a generator and at least one end consumer, wherein the regulating transformer comprises a primary winding and a regulating winding which includes switchable partial windings and a high leakage impedance;
conducting a nominal current in the regulating transformer;
switching the partial windings of the regulating transformer with a transfer switch; and
short circuiting adjacent tappings of the partial windings,
wherein the high leakage impedance limits a ring current to an order of magnitude of the nominal current during the short circuiting, and
wherein the regulating transformer produces both an increase in voltage and a decrease in voltage at the end consumer.

37. The method of claim 36, wherein the regulating transformer is a longitudinal transformer.

38. The method of claim 36, wherein the regulating transformer is one of a full transformer and a single winding transformer.

39. The method of claim 36, wherein the regulating winding is connected to the primary winding.

40. The method of claim 36, wherein the regulating transformer further comprises a secondary winding and wherein the regulating winding is connected to one of the primary winding and the secondary winding.

41. The method of claim 36, wherein the regulating transformer is adapted to regulate voltages in the range of 10 kVA and 10 MVA.

42. An apparatus for regulating an electric voltage in at least one of electric supply networks and consumer units, the apparatus comprising:
a regulating transformer arranged between a generator and at least one end consumer;
the regulating transformer comprising a primary winding and a regulating winding which includes switchable partial windings and a high leakage impedance, the transformer conducting a nominal current; and
a transfer switch that switches the partial windings of the regulating transformer,
wherein adjacent tappings of the partial windings are adapted to short circuit such that, in an event of the short circuit, the high leakage impedance limits a ring current which results from the short circuit to an order of magnitude of the nominal current, and
wherein the regulating transformer produces both an increase in voltage and a decrease in voltage at the end consumer.
